(19) United States
(12) Patent Application Publication
(10) Pub. No.: US 2014/0218278 A1
(43) Pub. Date: Aug. 7, 2014

(54) PORTABLE DEVICE AND OPERATION METHOD THEREFOR

(71) Applicant: HTC CORPORATION, Taoyuan County (TW)

(72) Inventors: Chao-Yi Chen, Taoyuan County (TW); Hsi-Kun Chen, Taoyuan County (TW)

(73) Assignee: HTC CORPORATION, Taoyuan County (TW)

(21) Appl. No.: 13/761,165

(22) Filed: Feb. 7, 2013

(51) Int. Cl. G06F 3/01

(52) U.S. Cl. CPC G06F 3/01
USPC 345/156

(57) ABSTRACT

A portable device and an operating method thereof are provided, wherein the portable device includes a key and a display, and the display is in a turned-off status. The operation method includes sensing an operating motion via the key, and producing a control signal to control the portable device according to the operating motion. The control signal turns on the display to show a read-only frame when the operating motion only includes a contact motion without inducing a physical displacement of the key. Alternatively, the control signal turns on the display to show an operational frame when the operating motion contains a contact motion and a physical motion inducing the physical displacement of the key.

### BACKGROUND

1. Field of the Invention

The present invention is directed to a portable device and more particularly, to a key of a portable device and an operating method thereof.

2. Description of Related Art

With development of mobile communication technology, portable devices that support functions, such as mobile communications, mobile Internet access and so on, are continuously developed and upgraded. In addition to variety of functional applications, appearance designs of the portable devices also become simpler and more stylish. Generally, a conventional portable device is commonly equipped with a physical keyboard, and an operation on a key of the physical keyboard is only divided to being pressed or not being pressed. However, under a trend of the portable device continuously becoming small-volume, if a key may be capable of providing more functions, the numbers of keys of the physical keyboard may be more effectively simplified.

### SUMMARY

The present invention is directed to a portable device and an operating method thereof. When a display of the portable device is in a turned-off status, the portable device is capable of sensing an operating motion of a user on the key, determining whether the operating motion of the user on the key is a contact motion or a press motion and controlling the display to show corresponding information according to the two types of operating motions of the user so as to improve functionality of the key.

The present invention provides a portable device adapted to a portable device, the portable device has a key and a display, and the display is in a turned-off status. The method includes sensing an operating motion via the key and producing a control signal to control the portable device according to the operating motion. When the operating motion only includes a contact motion without inducing a physical displacement of the key, the control signal turns on the display to show a read-only frame. When the operating motion includes the contact motion and a physical motion inducing the physical displacement of the key, the control signal turns on the display to show an operational frame.

In an embodiment of the present invention, after the step of the control signal turning on the display to show the read-only frame, the operating method of the portable device further includes automatically turning off the display after the contact motion disappears or a predetermined period.

In an embodiment of the present invention, after the step of the control signal turning on the display to show the operational frame, the operating method of the portable device further includes turning off the display when the key senses the physical motion via the key.

In an embodiment of the present invention, the key includes a contact sensor and a displacement sensor. The contact sensor is configured to sense the contact motion to produce a contact signal. The displacement sensor is configured to sense the physical motion to produce a displacement signal.

In an embodiment of the present invention, the step of sensing the operating motion via the key further producing an input signal. The input signal is the contact signal or a combination of the contact signal and the displacement signal.

The present invention provides a portable device including a key, a display, storage medium and a processor. The storage medium is configured to store a computer read/write program, and the processor is configured to execute a plurality of instructions of the computer read/write program. The instructions include sensing an operating motion via the key to produce an input signal. The processor produces a control signal to control the display according to the input signal. When the input signal indicates that the operating motion only includes a contact motion without inducing a physical displacement of the key, the control signal turns on the display to show a read-only frame. When the input signal indicates that the operating motion includes the contact motion and a physical motion inducing the physical displacement of the key, the control signal turns on the display to show an operational frame.

In an embodiment of the present invention, the key includes a contact sensor sensing the contact motion to produce a contact signal and a displacement sensor sensing the physical motion to produce a displacement signal. The input signal is the contact signal or a combination of the contact signal and the displacement signal.

In an embodiment of the present invention, the contact sensor is disposed above the displacement sensor.

In an embodiment of the present invention, the contact sensor includes a capacitive sensor and an optical sensor.

In an embodiment of the present invention, the key includes a top cover covering the contact sensor and the displacement sensor. A material of the top cover comprises a plastic material or a light-transmissive material.

In an embodiment of the present invention, after the instruction of the control signal turning on the display to show the read-only frame, the instructions further include automatically turning off the display after the contact motion disappears or a predetermined period.

In an embodiment of the present invention, after the instruction of the control signal turning on the display to show the operational frame, the instructions further include turning off the display when receiving the input signal including the displacement signal via the key.

To sum up, the present invention is directed to a portable device and an operating method thereof. In the portable device, an operating motion of a user on a key is sensed, and whether the operating motion of the user on the key is a contact motion or a press motion is determined. If the operating motion of the user on the key is a contact motion, the display shows a read-only frame, if the operating motion of the user on the key is a press motion, the display shows an operational frame, and thereby, functionality of the key is improved.

In order to make the aforementioned and other features and advantages of the present invention more comprehensible, several embodiments accompanied with figures are described in detail below.

### BRIEF DESCRIPTION OF THE DRAWINGS

The accompanying drawings are included to provide a further understanding of the present invention, and are incorporated in and constitute a part of this specification. The drawings illustrate embodiments of the present invention and, together with the description, serve to explain the principles of the present invention.

FIG. 1 is a functional block diagram illustrating a portable device 100 according to an embodiment of the present invention.

FIG. 2 is a schematic diagram illustrating the key 200 in the portable device according to an embodiment of the present invention.

FIG. 3 is a flowchart illustrating an operating method according to an embodiment of the present invention.

FIG. 4 is a flowchart illustrating an operating method according to another embodiment of the present invention.

### DESCRIPTION OF EMBODIMENTS

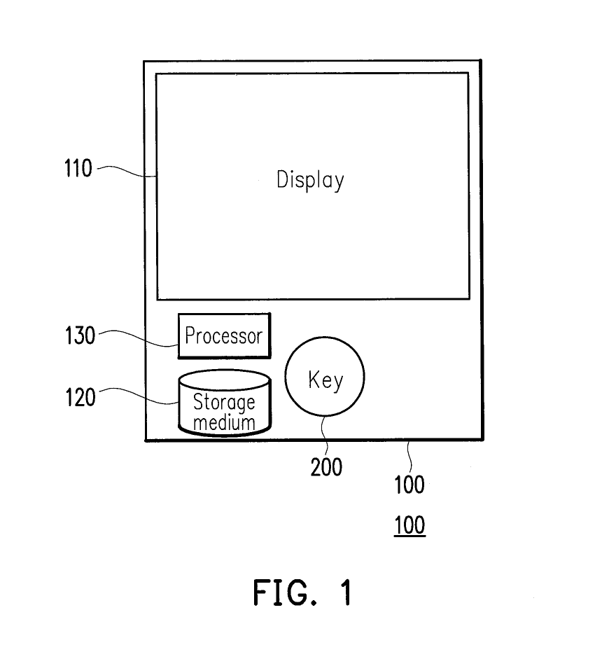

FIG. 1 is a functional block diagram illustrating a portable device 100 according to an embodiment of the present invention. Referring to FIG. 1, the portable device 100 includes a key 200, a display 110, a storage medium 120 and a processor 130. The key 200 is configured to sense an operating motion of a user, such as, a contact motion or a press motion, and convert the operating motion into an input signal. The display 110 is configured to show a read-only frame or an operational frame. In the read-only frame, information, such as a date, a time, a message, a missed call and so forth may be displayed, and the operational frame may be, for example, a homepage, but the present invention is not limited thereto. The storage medium 120 is configured to store a computer read/write program (Computer Read/Write Program).

The processor 130 is coupled to the key 200, the display 110 and the storage medium 120 and configured to execute the computer read/write program stored in the storage medium 120 and execute instructions by using the computer read/write program. The instructions include sensing via the key 200 an operating motion of a user, such as contacting or pressing the key 200, producing an input signal according to the operating motion of the user and producing a corresponding control signal to control the display 110 according to the input signal. When the input signal indicates that the operating motion of the user is a contact motion without inducing a physical displacement of the key 200 (for example, the user only touches the key 200 by a finger without operating any press motion on the key 200), the control signal turns on the display 110 to show the read-only frame. When the input signal indicates that the operating motion of the user includes the contact motion and a physical motion inducing the physical displacement of the key 200 (for example, the user first touches the key 200 and then presses down the key 200), the control signal turns on the display to show the operational frame.

In addition, in an embodiment, after the instruction of the control signal turning on the display 110 to show the read-only frame, the display 110 is automatically turned off when the contact motion of the user disappears or after a predetermined period, such as after showing the read-only frame for 5 seconds. In another embodiment, after the instruction of the control signal turning on the display 110 to show the operational frame, the display 110 is turned off when the key 200 receives the input signal indicates that the user presses down again the key 200.

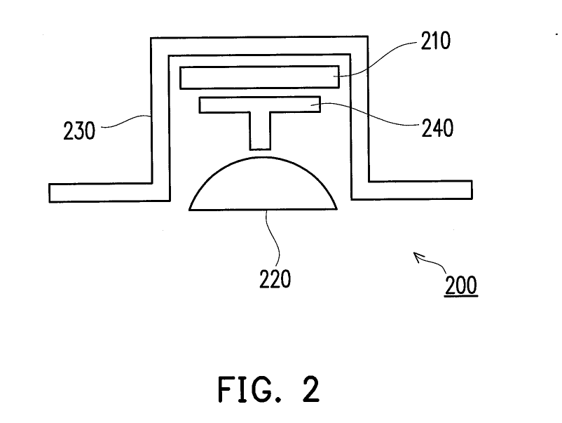

FIG. 2 is a schematic diagram illustrating the key 200 in the portable device according to an embodiment of the present invention. Referring to FIG. 2, the key 200 includes a contact sensor 210, a displacement sensor 220, a top cover 230 and a plunger 240. The top cover 230 covers the contact sensor 210 and the displacement sensor 220, and a material of the top cover 230 includes a plastic material or a light-transmissive material. The contact sensor 210 is disposed above the displacement sensor 220 and configured to sense the contact motion of the key to produce a contact signal. The contact sensor 210 is, for example, a capacitive sensor or an optical sensor.

The plunger 240 is disposed between the contact sensor 210 and the displacement sensor 220. The displacement sensor 220 is configured to sense a physical motion produced by the user pressing down the key 200 to produce a displacement signal. As such, when the press motion is produced on the key 200 by the user, a downward physical displacement is produced on the displacement sensor 220 by a pressure of the press motion via the top cover 230, the contact sensor 210 and the plunger 240. In the present embodiment, the displacement sensor 220 is represented by a hemispherical body. However, the present invention is not limited thereto, and the displacement sensor 220 may be any type of sensor, such as, a optical sensor, a pressure sensor, a thin-film sensor or the like, capable of sensing an inner space or a lower space of the key 200 being compressed and deformed due to a force.

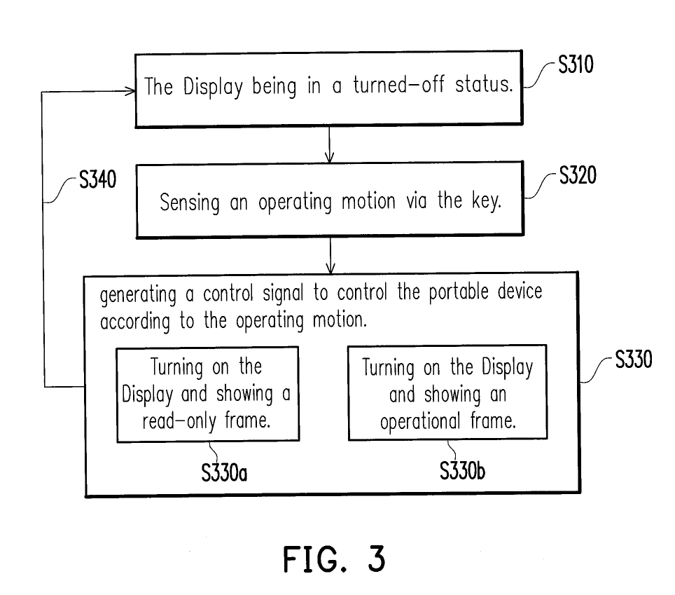

FIG. 3 is a flowchart illustrating an operating method according to an embodiment of the present invention. Referring to FIG. 3 together with FIG. 1 and FIG. 2, in step 5310, the display 110 of the portable device 100 is in a turned-off status. However, in an embodiment, the portable device 100 may be in a standby or a sleep status. Then, in step S320, an operating motion of the user is sensed via the key 200. To be more specific, the operating motion is produced on the key 200 by the user, and the operating motion of the user is sensed by the contact sensor 210 and/or the displacement sensor 220 beneath the top cover 230 of the key 200, so as to produce an input signal.

Thereafter, in step 5330, a control signal is produced to control the portable device 100 according to the sensed operating motion. That is to say, the processor 130 produces a corresponding control signal according to the input signal produced by the sensed operating motion to control the display 110 of the portable device 100 to show different frames according to different operating motions (operational behaviors) applied by the user on the same key.

To be more specific, in step S330a, when the operating motion of the user is a contact motion without inducing a physical displacement of the key 200, the control signal turns on the display 110 to show the read-only frame. For example, the user contacts the key 200 by an input means (e.g., a finger or a stylus pen), instead of actually pressing down the key 200 to induce the physical displacement of the key 200. Namely, the operating motion of the user does not induce the displacement sensor 220 in the key 200 to sense any spatial change, and an input signal produced by the key 200 corresponding to the operating motion of the user includes only the contact signal. Accordingly, the control signal produced according to the input signal (including only the contact signal) controls the display 110 to show the read-only frame.

On the other hand, in step S330b, when the operating motion of the user includes the contact motion and a physical motion (e.g., the user pressing the key 200 by the input means) inducing a physical displacement of the key 200, the control signal turns on the display 110 to show the operational frame. Namely, when the contact sensor 210 in the key 200 senses the contact motion of the operating motion of the user to produce the contact signal, while the displacement sensor 220 senses the physical motion to produce the displacement signal, the input signal produced by the key 200 sensing the operating motion is composed of the contact signal and the displacement signal. Accordingly, the control signal produced according to the input signal controls the display 110 to show the operational frame.

In an embodiment, after the control signal turns on the display to show the read-only frame (step S330a), the processor 130 automatically turns off the display and returns to the status of step 5310 (step S340) when the contact motion of the user on the key 200 disappears or after a predetermined period. Namely, after controlling the display 110 to show the read-only frame, the processor 130 automatically turns off the display if the user moves away the input means contacting the key 200 or no contact signal or input signal is received within a predetermined period.

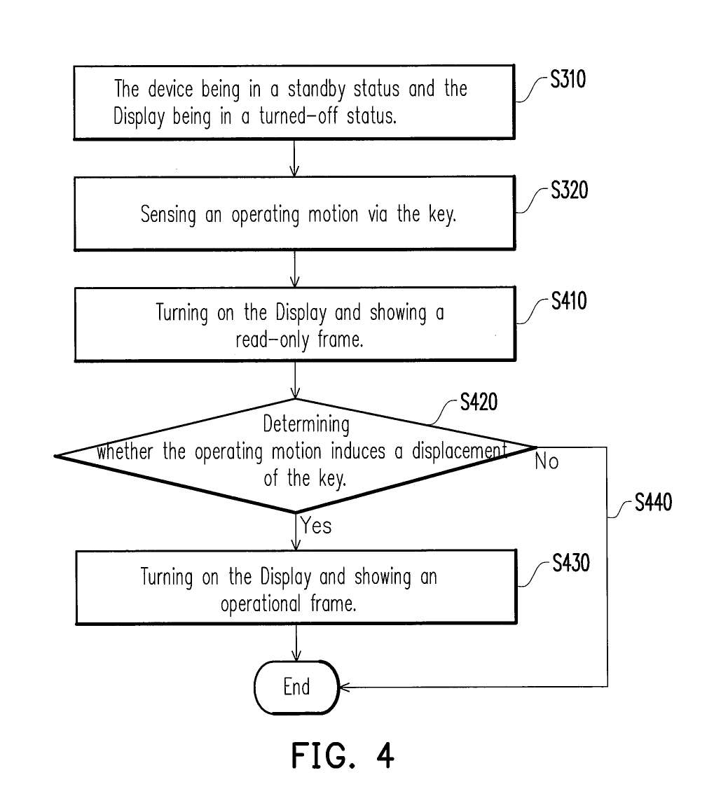

In another embodiment, after the control signal turns on the display 110 to show the operational frame (step S330b), the processor 130 produces another control signal to turn off the display according to the input signal and returns to the status of step S310 when the processor 130 receives again the input signal including the displacement signal which is produced by the displacement sensor 220 according to the physical displacement applied on the key 200 by the user (step S340). Namely, after the processor 130 controls the display 110 to show the operational frame, the processor 130 turns off the display according to the input signal when the user induces the physical displacement of the key by using the input means to produce the input signal again. FIG. 4 is a flowchart illustrating an operating method according to another embodiment of the present invention. Referring to FIG. 4 together with FIG. 1 and FIG. 2, step S310˜step S320 of the operating method in FIG. 4 is respectively the same as step S310˜step S320 in FIG. 3.

In step S410, according to an input signal including a contact signal which is produced according to an operation motion sensed by the key 200, the processor 130 produces a corresponding control signal to turn on the display 110 to show the read-only frame. That is to say, no matter whether the user induces a physical displacement of the key by using an input means, the processor 130 turns on the display to show the read-only frame accordingly as long as the input means of the user contacts the key. Then, in step S420, the processor 130 confirms whether an operating motion of the user on the key 200 induces the contact sensor 210 to produce a contact signal and further induces the displacement sensor 220 to sense a physical displacement according to the input signal from the key 200. When confirming that the operating motion of the user further includes a physical motion inducing the physical displacement of the key, the processor 130 produces the control signal to induce the display to show an operational frame (step S430).

On the other hand, when the operating motion of the user only includes a contact motion without inducing the physical displacement of the key 200, that is, the operating motion of the user does not induce the displacement sensor 220 to sense the key 200 producing the physical displacement, the operating method ends (step S440).

Namely, in the present embodiment, when the user presses down the key 200 by using the input means, the operating motion of the user includes series of contact motions and the following physical motions. Accordingly, the display first shows the read-only frame and further switches to the operational frame. However, the present invention is not limited thereto. Namely, in another embodiment, when a time difference between the contact motion and the following physical motion is smaller than a predetermined difference value, the processor 130 produces the control signal accordingly to induce the display 110 to show the operational frame directly.

Based on the above, the present invention is directed to a portable device and an operating method thereof. In the portable device, an operating motion of a user on a key is sensed by a sensor, whether the operating motion of the user on the key only includes a contact motion or includes the contact motion and a physical press motion inducing a displacement of the key is determined. If the operating motion of the user on the key only is merely the contact motion, the display shows a read-only frame, and f the operating motion of the user on the key is a physical press motion, the display shows an operational frame, and thereby, functionality of the key is improved.

Although the invention has been described with reference to the above embodiments, it will be apparent to one of the ordinary skill in the art that modifications to the described embodiment may be made without departing from the spirit of the invention. Accordingly, the scope of the invention will be defined by the attached claims not by the above detailed descriptions.

What is claimed is:

1. An operation method, adapted to a portable device having a key and a display, and the display being in a turned-off status, the method comprising:
sensing an operating motion via the key; and
producing a control signal to control the portable device according to the operating motion, wherein:
when the operating motion only comprises a contact motion without inducing a physical displacement of the key, the control signal turns on the display to show a read-only frame, and
when the operating motion comprises the contact motion and a physical motion inducing the physical displacement of the key, the control signal turns on the display to show an operational frame.

2. The method according to claim 1, wherein after the step of the control signal turning on the display to show the read-only frame, the method further comprises:
automatically turning off the display after the contact motion disappears or a predetermined period.

3. The method according to claim 1, after the step of the control signal turning on the display to show the operational frame, the method further comprises:
turning off the display when the key senses the physical motion via the key.

4. The method according to claim 1, wherein the key comprises:
a contact sensor, sensing the contact motion to produce a contact signal; and
a displacement sensor, sensing the physical motion to produce a displacement signal.

5. The method according to claim 4, wherein the step of sensing the operating motion via the key further comprises producing an input signal, wherein the input signal is the contact signal or a combination of the contact signal and the displacement signal.

6. A portable device, comprising:
a key;
a display;
a storage medium, storing a computer read/write program; and
a processor, executing a plurality of instructions of the computer read/write program, wherein the plurality of instructions comprises:
sensing an operating motion via the key to produce an input signal ; and
producing a control signal to control the display according to the input signal, wherein the control signal turns on the display to show a read-only frame when the input signal indicates that the operating motion only comprises a contact motion without inducing a physical displacement of the key, and the control signal turns on the display to show an operational frame when the input signal indicates that the operating motion comprises the contact motion and a physical motion inducing the physical displacement of the key.

7. The portable device according to claim 6, wherein the key comprises a contact sensor sensing the contact motion to produce a contact signal and a displacement sensor sensing the physical motion to produce a displacement signal, wherein the input signal is the contact signal or a combination of the contact signal and the displacement signal.

8. The portable device according to claim 7, wherein the contact sensor is disposed above the displacement sensor.

9. The portable device according to claim 7, wherein the contact sensor comprises a capacitive sensor and an optical sensor.

10. The portable device according to claim 7, wherein the key comprises a top cover covering the contact sensor and the displacement sensor, wherein a material of the top cover comprises a plastic material or a light-transmissive material.

11. The portable device according to claim 6, wherein after the instruction of the control signal turning on the display to show the read-only frame, the plurality of instructions further comprises:
automatically turning off the display after the contact motion disappears or a predetermined period.

12. The portable device according to claim 6, wherein after the instruction of the control signal turning on the display to show the operational frame, the plurality of instructions further comprises:
turning off the display when receiving the input signal comprising the displacement signal via the key.
